(19) United States
(12) Patent Application Publication
(10) Pub. No.: US 2026/0113569 A1
(43) Pub. Date: Apr. 23, 2026

(54) Wearable Audio Device with Toroidal Form Factor

(71) Applicant: Dopple IP B.V., Assen (NL)

(72) Inventors: Jacobus Cornelis Haartsen, Rolde (NL); Johannes Lucas Schreuder, Ees (NL)

(21) Appl. No.: 19/340,110

(22) Filed: Sep. 25, 2025

Related U.S. Application Data
(60) Provisional application No. 63/698,625, filed on Sep. 25, 2024.

(51) Int. Cl. H04R 1/10; G10K 11/178; H01Q 1/27; H01Q 7/00; H04R 1/08; H04R 1/32; H04R 3/00; H04R 29/00

(52) U.S. Cl. CPC H04R 1/1083; G10K 11/17881; H01Q 1/273; H01Q 7/00; H04R 1/08; H04R 1/1016; H04R 1/1025; H04R 1/323; H04R 3/002; H04R 29/001; H04R 2420/07

(57) ABSTRACT

A true wireless headset system includes two earpieces and a cradle configured to store and wirelessly recharge the earpieces. Each earpiece has a donut shaped housing. The earpiece is placed in the concha of a user's ear. The earpiece includes an ear tip placed in a canal of the user's ear that substantially blocks ambient sound. The earpiece includes a main washer-shaped PCB having a central through hole. The earpiece additionally includes a circular RF antenna in the housing, spaced away from the main PCB, a rechargeable battery, and an energy receiving coil.

The cradle includes a housing, with a recess to hold each earpiece; a vertical pin configured to protrude through the through hole in the center of the earpiece; and an energy transmitting coil configured to create a magnetic field coupling the energy transmitting coil to the energy receiving coil to wirelessly transfer energy to the earpiece.

### RELATED APPLICATIONS

This application claims the benefit of U.S. Provisional Application No. 63/698625, filed 25 Sep. 2024, the entire disclosure of which being hereby incorporated by reference herein.

### FIELD OF INVENTION

The present invention relates generally to electronics devices worn in the ear, such as earpieces for voice communications and music listening, and in particular to earpieces having a toroidal, or donut-shaped housing. In addition, the invention relates to earpieces used for active and passive hearing protection.

### BACKGROUND

The use of audio devices, such as headsets and headphones, wirelessly connected to host devices like smartphones, laptops, and tablets, is becoming increasingly popular. Whereas consumers used to be tethered to their electronic devices with wired headsets, wireless headsets are gaining more traction due to the improved user experience, providing the user more freedom of movement and ease of use. Wireless audio devices allow the user to enjoy untethered music entertainment and voice communications. Further momentum for wireless headsets has been gained by certain smartphone manufacturers abandoning the implementation of the 3.5 mm audio jack in the smartphone for wired connections, and promoting voice communications and music listening wirelessly, for example by using BLUETOOTH® technology.

Headsets and headphones come in many forms and with many features. Over-the-ear stereo headsets allow immersive listening to high quality sound. In-ear stereo headsets (earpieces placed in the ear canal or in the concha) are more flexible and provide less presence to the user. Most of these in-ear stereo headsets and headphones consist of a left and right earpiece connected with a cable or neckband. More recent designs offer a separate left and right earpiece with no physical connection between the buds. Examples of these so-called True Wireless headsets include the Apple AIRPODS® and the Samsung ICONX®.

In many environments, people are exposed to loud noises. For example, people visit music festivals where the sound levels are typically above the level where hearing damage may occur. Factory workers, construction builders, and professionals working in (e.g., the music) industry are frequently exposed to loud sound levels. The examples also include environments such as airplanes, offices, public transportations, and sports arenas. More and more people are wearing earplugs to reduce the sound level arriving at their ear drums, thus avoiding hearing loss which typically results from exposure to loud sound levels over a long duration of time. Passive earplugs are widely used for hearing protection, providing noise reduction by physically blocking sound from entering the ear canal. The problem with the passive earplugs is that communication is difficult because the ear canal is blocked. As a result, many people remove their hearing-protecting earplugs when they wish to communicate, be it via a (smart)phone or orally to a person nearby. Combining the technology used in wireless headsets with hearing protection measures is one way to solve the communication problem in loud environments. For professionals working in loud environments, the combination of wireless headsets and hearing protection measures improves the quality of life because in addition to communications, they may use their headset to listen to their favorite music or podcast while working.

Many people suffer from hearing loss. Partly because they have been exposed to loud noise, as discussed above, or because of aging which is known to affect the human hearing capabilities. Active earpieces that include electronics to pick up the surrounding sounds like television, traffic, and voices, and subsequently amplify and equalize the signals before they are provided to the loudspeaker, may significantly help hearing-impaired people in their daily lives.

The performance of electronic devices worn in the ear is plagued by environmental substances like ear wax, (salty) water, sweat, dust, body lotion, sunburn oil, and so on. For proper acoustic performance, earpieces may have holes and vents to the inner part of the earpiece structure. For examples, microphones require an open tube to the outside; likewise, vents leading to internal acoustic cavities around the loudspeaker are needed for an effective acoustic operation. By handling the earpieces by human hands and wearing them in the ear, the vents and tubes are easily clogged with dirty substances. Although meshes may be used to keep out a certain amount of dirtiness, they are not sufficient in the long term as they are clogged as well. Furthermore, earpieces usually have galvanic contacts in order to charge the onboard batteries when the earpieces are placed in a charging station or cradle. These galvanic contacts are prone to contamination and are polluted as well by environmental substances when used. Polluted contacts hamper the charging function, leading to longer charging times or malfunctioning.

The state of the art in wearable audio devices is thus characterized by a proliferation of devices, each dedicated to separate functions, such as communication and music listening, hearing protection in loud environments, and hearing aid functionality for users suffering hearing loss. Not only can such separate devices not be utilized at the same time, but many of them are not robust in harsh environments, with exposure to unfavorable substances.

The Background section of this document is provided to place embodiments of the present invention in technological and operational context to assist those of skill in the art in understanding their scope and utility. Unless explicitly identified as such, no statement herein is admitted being prior art merely by its inclusion in the Background section.

### SUMMARY

The following presents a simplified summary of embodiments of the invention in order to provide a basic understanding to those of skill in the art. This summary is not an extensive overview of the invention and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described herein, an earpiece is presented with a generally toroidal-shaped housing, generally referred to herein by its more common characterization, as being shaped like a donut. The donut housing fits into the ear concha of the user and has a hole in the middle. A coin-cell shaped battery of the earpiece is positioned perpendicular to the donut housing and is located close to, and may partly fall into, the ear canal. The entrances of tubes leading to microphones may be located in the side wall of the hole, thus reducing the impact of wind noise, and reducing clogging from debris as the earpieces are not handled from within the hole.

In one embodiment, the donut housing includes a coil for wireless charging, wherein the center of the coil is centered to the hole in the donut housing. Ferromagnetic rings may be added to enhance the magnetic fields around the coil. In one embodiment, the charging coil is placed as far from a Radio Frequency (RF) antenna as possible. In another embodiment, the RF antenna and charging coil consist of the same metal layer on a Printed Circuit Board (PCB).

One embodiment relates to the cradle to be used in combination with the donut shaped earpiece. A pin in the cradle is used to align the charging coil in the cradle with the charging coil in the earpiece. The pin may be made of ferromagnetic materials in order to enhance the magnetic fields in the coils.

Another embodiment relates providing transparency for the user in order to hear his environment. Passive transparency may be accomplished with canals or tubes in the donut shaped earpiece that may be closed and opened with valves which are controlled electronically. In some embodiments, the canals end at the back of the loudspeaker, where the loudspeaker membrane acts as a damper for hearing protection. Active transparency can be provided by microphones listening to the environment and providing signals to an internal loudspeaker in the donut shaped earpiece. A combination of passive and active transparency can give the optimal hearing experience while still protecting against loud noises. Spectral analysis of the sounds in the environment may provide the optimal settings for best transparency with maximal hearing protection. Alternatively, via a wireless link (or possibly a QR code using a smartphone), tools and machines may provide the earpieces with optimal settings to provide transparency and still suppress the loud noise unique for the tool or machine.

In one embodiment, internal microphones located near the ear canal can be used to apply leakage tests and damping tests. These microphones can also be used for dosimetering, logging the amount of noise to which the user is exposed for a long periods of time. Internal microphones can also be used in feedback loops using anti-sound for active noise suppression or reducing the occlusion effect.

In one embodiment, wireless communication towards the earpiece may warn the user of nearby dangers like an approaching vehicle, while still wearing his earpieces for hearing protection. In another embodiment, transparency and protection settings are provided by a wireless hub or base station, containing data settings unique for the environment in which the user is located. In some embodiment, ranging methods may be used so that the user settings are only affected when the users is close to the hub.

One embodiment relates to a wearable, true wireless earpiece. The earpiece includes a donut shaped housing having a through hole in the center. The earpiece is shaped and configured to be placed in a concha of a user's ear. The earpiece includes an ear tip shaped and configured to be placed in a canal of the user's ear. The ear tip is shaped and configured to substantially block ambient sound from the user's ear. The ear tip has a central bore comprising a third acoustic tube configured to carry sound to the user's ear. The earpiece further includes a main washer-shaped Printed Circuit Board (PCB) having a central through hole. The main PCB is disposed in the housing and provides physical support and electrical connectivity to electronic circuits disposed thereon and configured to perform communication and audio processing functions. The earpiece additionally includes a circular Radio Frequency (RF) antenna disposed within the housing, and spaced away from the main PCB.

Another embodiment relates to a cradle configured to store and wirelessly recharge batteries in first and second earpieces of a true wireless headset. The cradle comprises a housing and includes, for each earpiece: a recess conforming to the donut shaped housing the earpiece and configured to hold the earpiece; a generally vertical pin sized centrally located in the recesses and configured to protrude through the through hole in the center of the earpiece; an energy transmitting coil configured to create a magnetic field coupling the energy transmitting coil to the energy receiving coil and to wireless transfer energy to the earpiece; and circuitry configured to control the energy transmitting coil.

Another embodiment relates to a true wireless headset system, including first and second earpieces and a cradle configured to store and wirelessly recharge batteries in the first and second earpieces. Each earpiece includes a donut shaped housing having a through hole in the center. The earpiece is shaped and configured to be placed in a concha of a user's ear. The earpiece includes an ear tip shaped and configured to be placed in a canal of the user's ear. The ear tip is shaped and configured to substantially block ambient sound from the user's ear. The ear tip has a central bore comprising a third acoustic tube configured to carry sound to the user's ear. The earpiece further includes a main washer-shaped Printed Circuit Board (PCB) having a central through hole. The main PCB is disposed in the housing and provides physical support and electrical connectivity to electronic circuits disposed thereon and configured to perform communication and audio processing functions. The earpiece additionally includes a circular Radio Frequency (RF) antenna disposed within the housing, and spaced away from the main PCB. The earpiece further includes a power circuit comprising a rechargeable battery, an energy receiving coil, and electronic configured to recharge the battery using power received by the energy receiving coil. The cradle includes a housing, and includes, for each earpiece: a recess conforming to the donut shaped housing the earpiece and configured to hold the earpiece; a generally vertical pin sized centrally located in the recesses and configured to protrude through the through hole in the center of the earpiece; an energy transmitting coil configured to create a magnetic field coupling the energy transmitting coil to the energy receiving coil and to wireless transfer energy to the earpiece; and circuitry configured to control the energy transmitting coil.

### BRIEF DESCRIPTION OF THE DRAWINGS

The present invention will now be described more fully hereinafter with reference to the accompanying drawings, showing several embodiments of the invention. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 shows a high-level schematic diagram of an exemplary use scenario of a user using a host device such as a smartphone, a wireless stereo headset, and a cradle according to aspects of the invention.

FIG. 2 is a first schematic block diagram of an exemplary wireless earpiece according to aspects of the invention.

FIG. 3 is a second schematic block diagram of an exemplary wireless earpiece according to aspects of the invention.

FIG. 4A is a perspective view of an earpiece with a donut form factor, showing substantially the top side.

FIG. 4B is a perspective view of an earpiece with a donut form factor, showing substantially the bottom side.

FIG. 4C is a diagram of a human ear with a donut form factor earpiece inserted.

FIG. 5A is a perspective view of some internal parts of the earpiece shown in FIG. 4A, showing substantially the top side.

FIG. 5B is a perspective view of some internal parts of the earpiece shown in FIG. 4B, showing substantially the bottom side.

FIG. 6A is an exemplary diagram of a PCB for wireless charging in the earpiece shown in FIGS. 4A-4C.

FIG. 6B is a more detailed top view of the wireless charging PCB of FIG. 6A, showing a receive coil.

FIG. 7 is a cross-sectional view of the donut shaped earpiece, showing the PCBs implementing the electronics of FIG. 2 or FIG. 3, according to one embodiment.

FIG. 8 is a cross-sectional view of the donut shaped earpiece in a wireless charging construction according to a first embodiment.

FIG. 9 is a cross-sectional view of the donut shaped earpiece in a wireless charging construction according to a second embodiment.

FIG. 10 is a cross-sectional view of the donut shaped earpiece in a wireless charging construction according to a third embodiment.

FIG. 11 is a cross-sectional view of the donut shaped earpiece in a wireless charging construction according to a fourth embodiment.

FIG. 12A is a cross-sectional view of the donut shaped earpiece in a wireless charging construction according to a fifth embodiment.

FIG. 12B is a perspective view of a coil and support in the wireless charging construction of FIG. 12A.

FIG. 13 is a cross-sectional view of the donut shaped earpiece in a wireless charging construction where the receiving charge coil and the RF antenna make use of the same wired construction.

FIG. 14A is a high-level schematic diagram of a charging station or cradle.

FIG. 14B is a high-level diagram of an exemplary use scenario of a user using a host device like a smartphone, a wireless stereo headset, and a wireless microphone according to aspects of the invention.

FIG. 15 is a cross-sectional view of the donut shaped earpiece, showing acoustic tubes and air microphones according to one embodiment.

FIG. 16 is a cross-sectional view of the donut shaped earpiece, showing acoustic tubes and air microphones according to another embodiment.

FIG. 17 is an exemplary diagram of an earpiece showing audio components and acoustic structures according to aspects of the invention.

FIG. 18 is a first high-level schematic block diagram showing audio aspects of the invention.

FIG. 19 is a second high-level schematic block diagram showing audio aspects of the invention.

FIG. 20 is a high-level diagram of an exemplary use scenario of a user using a wireless stereo headset connected to a hotspot according to aspects of the invention.

FIG. 21 is a high-level schematic diagram of an exemplary use scenario of a user using a hearing protecting headset with a warning method for nearby vehicles according to aspects of the invention.

### DETAILED DESCRIPTION

For simplicity and illustrative purposes, the present invention is described by referring mainly to exemplary embodiments thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

Electronic devices, such as mobile phones and smartphones, are in widespread use throughout the world. Although the mobile phone was initially developed for providing wireless voice communications, its capabilities have increased tremendously. Modern mobile phones can access the worldwide web, store a large amount of video and music content, include numerous applications (“Apps”) that enhance the phone's capabilities (often taking advantage of additional electronics, such as still and video cameras, satellite positioning receivers, inertial sensors, and the like), and provide an interface for social networking. Many smartphones feature a large screen with touch capabilities for easy user interaction. In interacting with modern smartphones, wearable headsets are often preferred for enjoying private audio, for example carrying voice communications, gaming, music listening, or watching video, thus not interfering with or irritating other people sharing the same area. Because it represents such a major use case, embodiments of the present invention are described herein with reference to a smartphone, or simply “phone” as the host device. However, those of skill in the art will readily recognize that embodiments described herein are not limited to mobile phones, but in general apply to any electronic device capable of providing audio content.

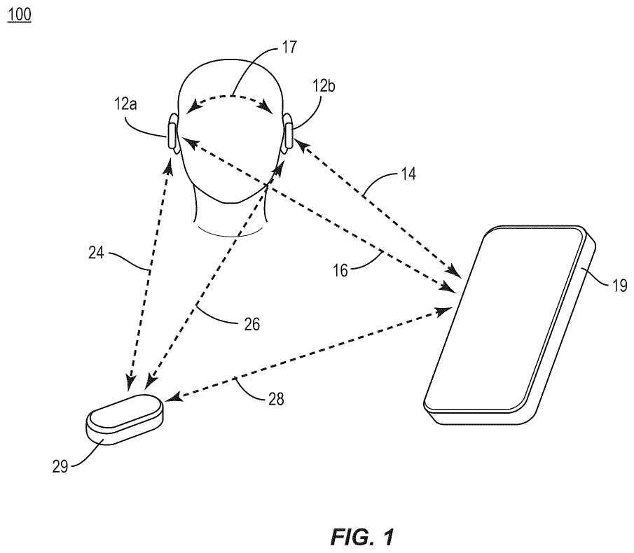

FIG. 1 depicts a representative use case 100, in which a host device 19, such as a smartphone, contains audio content which may stream over wireless connection 16 and/or 14 towards the right earpiece 12a and/or left earpiece 12b of the headset 12. Headset 12 preferably consists of two separate earpieces 12a/12b, forming a so-called True-Wireless headset 12. The headset and its constituent earpieces are collectively referred to herein by the reference numeral 12. When discussing one or the other individual earpiece, they may be designated as 12a for the right earpiece and 12b for the left earpiece, where “right” and “left” are from the perspective of the user, as depicted in FIGS. 1, 14B, 20, and 21. Where the two earpieces are referenced collectively but distinction between right and left is not critical, they may be referred to as 12a/12b, or simply 12.

Communication between the earpieces 12a, 12b (ear-to-ear or e2e communications) is provided via connection 17, which may be wireless. When not in use, True-wireless earpiece 12 may be stored in cradle 29 which may also provide (re-)charging functionality. For status information, a wireless communication link 24 and/or 26 may exist between cradle 29 and earpieces 12a, 12b respectively.

Cradle 29 may also contain storage capabilities for music that may be streamed over links 24 and 26 to the earpieces. Alternatively, cradle 29 may be connected via a USB wire and/or 3.5 mm jack to a sound system (including, e.g., the sound system provided in airplanes).

Cradle 29 may also have wireless link 28 to the host device 19. Music stored in the host device 19 may be sent to cradle 29 over wireless connection 28 and subsequently be forwarded by cradle 29 to earpieces 12 using wireless connections 24 and 26. This allows the use of a proprietary wireless protocol over links 24 and 26 that is not supported by host device 19. Wireless connections 14 and 16 may also use a proprietary protocol in which case a Universal Serial Bus (USB), or other standard protocol, dongle (not shown) may be needed that fits into the host device 19 and which converts the proprietary wireless signals to standard signals recognized by the host device 19 and vice versa. Cradle 29 may have a (touch) display and User Interface (UI) capabilities to control the audio functions, or the host device may act as a remote control to control (audio) functions in the cradle 29.

Comfortable headsets that can be worn all day preferably use in-ear type earpieces 12 that are worn within the ear canal and/or concha. Because these earpieces 12 block the ear canal for environmental noise, they may also be used for hearing protection when the user is in an environment with loud noise. Since the earpiece 12 also includes audio components such as microphones, loudspeakers, and signal processing circuitry such as amplifiers and digital processors, environmental sound may also be picked up and processed before being presented to the user's eardrum. This allows hearing aid functionality in the earpieces 12 that will help users that are hearing-impaired. The user in FIG. 1 may isolate himself from the environment in case of loud sounds while still being able to communicate wirelessly and/or listen to music. In a noise-free environment, the user may turn on audio enhancing functions in the earpieces 12 to better hear the environment and/or compensate for hearing loss. With an App on the smartphone 19, the user may tune his settings, choose a profile that matches the environment, and control other functionality in the earpieces 12.

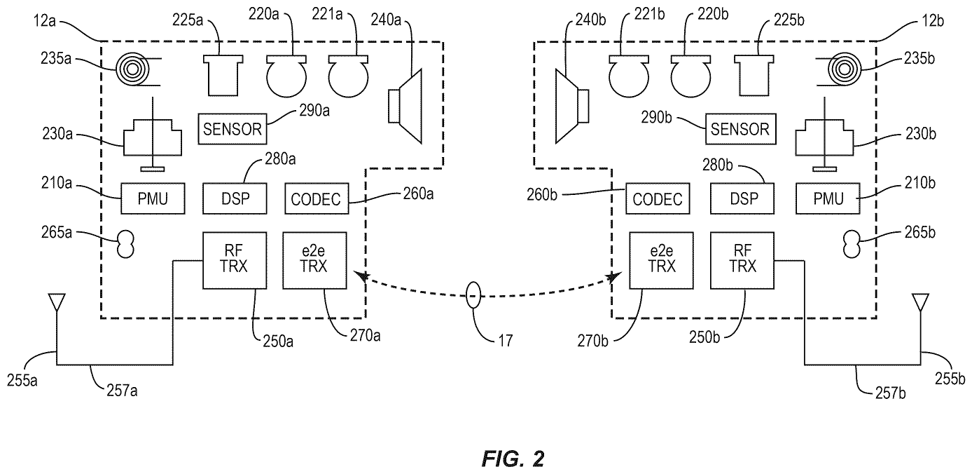

FIG. 2 shows a high-level functional schematic diagram 200 of an exemplary wireless stereo headset 12 consistent with aspects of the invention. Earpieces 12a and 12b consist substantially of the same components, although the placement inside the earpiece (e.g., on the PCB) may be different, for example mirrored. Wireless communication via links 14 and/or 16 between the host device and the headset 12 is provided by an antenna 255a and a radio transceiver 250a in the right earpiece 12a, and/or is provided by an antenna 255b and a radio transceiver 250b in the left earpiece 12b. Antennas 255a and 255b may be dimensioned to receive and transmit radio signals at carrier frequencies in the GHz range, for example carrier frequencies that are found in the 2.4 GHz ISM band ranging from 2400 MHz to 2483.5 MHz. Antennas 255a and 255b are connected via connectors 257a and 257b to radio transceivers 250a and 250b.

Radio transceivers 250a and 250b are low-power radios covering short distances, for example radios based on the Bluetooth wireless standard (e.g., operating in the 2.4 GHz ISM band). The use of radio transceivers 250a and 250b, which by definition provide two-way communication capability, allows for efficient use of airtime (and consequently low power consumption) because it enables the use of a digital modulation scheme with an automatic repeat request (ARQ) protocol. Transceivers 250a and 250b may include a microprocessor (not shown) controlling the radio signals, applying audio processing (for example voice processing, such as echo suppression and music decoding) on the signals exchanged with radio transceivers 250a and 250b, and/or may control other devices and/or signal paths within the earpieces 12a and 12b, respectively. Alternatively, audio processing may be carried out in a separate digital signal processor (DSP) 280 in the earpiece 12, or in a digital processor integrated into another component present in the earpiece 12, i.e., integrated into radio transceiver 250. Advanced audio algorithms may be carried out in DSP 280, such as beam forming, echo cancellation, and noise suppression (including active noise cancellation, ANC).

Additionally or alternatively, advanced hearing aid algorithms may be carried out in the DSP 280 to improve the hearing capabilities of the user. The algorithms may make use of Artificially Intelligence (Al) and/or Machine Learning (ML) algorithms. A Neural Network Processor (NNP) may be present (not shown). It may be embedded in DSP 280 or radio transceiver 250. Using parameters found via ML, the NNP allows low-power, always-on processing capabilities, for example for Voice Activation Detection (VAD), HotWord detection (HWD), KeyWord detection (KWD), and Context detection. The NNP may use a Convolutional Neural Network (CNN), a Deep Neural Network (DNN), a Recurrent Neural Network (RNN), or a combination thereof. Codecs 260a and 260b include Digital-to-Analog (D/A) converters, the outputs of which connect to a right loudspeaker 240a and left loudspeaker 240b, respectively. For embodiments that include a voice and/or transparency mode (including hearing aid functionality), the codecs 260a and/or 260b may further include Analog-to-Digital (A/D) converters that receive input signals from first analog air microphones 220a and 220b, respectively. To obtain beamforming for enhanced voice pickup, more than one first microphone 220 may be embedded in one earpiece 12, then also requiring additional Analog-to-Digital (A/D) converters in the codec 260. To support ANC, a second, in-ear microphone 221 may be placed in front of the loudspeaker 240. Instead of analog microphones, digital microphones that do not need A/D conversion may be applied, which feed their output directly to the microprocessor or the DSP 280. In addition to air microphones picking up the sound through air waves, vibration sensors 225a and/or 225b may be added to pick up acoustic vibrations. Vibration sensors may pick up the mechanical vibrations in the human skull caused by the user's vocal cords. Vibrations may be picked up via the skin (Skin Surface Microphones), from the bones (Bone Conduction microphone), or from other tissues in the user's head. The vibration sensor may for example be implemented by an accelerometer which may use Micro-Electro-Mechanical-System (MEMS) technology.

Sensor(s) 290 may be added to detect certain user characteristics or events. For example, an acceleration sensor may be added to detect movement, or an infrared sensor may be added for in-ear detection or for measuring physiological characteristics, such as the user's heart rate or blood oxygen saturation level. One or more Light Emitting Diodes (LEDs) may be added to allow Photoplethysmography (PPG) for detection of the heart rate and/or or oxygen saturation level. Magnetic sensors may be added for orientation detection (i.e., measuring earth magnetic field to determine whether the user lies down, on back, or on left or right side) or for detecting bruxism, and possibly heartrate and breathing. LEDs and sensors may also be used for UI purposes to control miscellaneous functionality in the headset 12. LEDs may indicate status (connection present, battery low, and so on). UI can be accomplished by buttons (not shown in FIG. 2), sensors for detecting gestures (gesture control), and so on. Alternatively, UI may be provided via smartphone 19.

Advanced algorithms may be carried out in DSP 280 to process the sensor signals. The sensor signals may be sent wirelessly to the smartphone 19, which may forward this information to a server in the cloud for storage or to a care professional. The algorithms may also trigger audio feedback to the user to overcome certain medical issues, such as freeze-of-gait for Parkinson patients, or anxieties for persons suffering of mental illness. The algorithms may use Artificial Intelligence and/or Machine Learning algorithms, and may reside partly or completely in the DSP 280, in the smartphone 19, and/or reside in the cloud.

Each earpiece 12 is powered by battery 230 which typically provides a 3.7V voltage and may be of the coin cell type. The battery 230 may be a primary battery, but is preferably a rechargeable battery. Power Management Units (PMU) 210a and 210b provide stable voltage and current supplies to all electronic circuitry, and also provide charging support functions to charge a rechargeable battery when the earpiece 12 is placed in a charging station or cradle. The charging may be wired through galvanic contacts 265 and/or may be wireless using magnetic coupling. In the latter case, a receive coil 235 is required to pick up the magnetic fields provided by a charging station.

To provide communications between the left and right earpiece, an ear-to-ear (e2e) link 17 is provided. The e2e transceivers 270a and 270b take care of the communication over e2e link 17. Link 17 may use magnetic coupling, for example using the Near-Field Magnetic Induction (NFMI) technology as provided by NXP NFMI radio chip Nx2280, or may use an RF link. Preferably, link 17 makes use of an RF protocol substantially the same as used in the links 14 and 16 between the earpieces 12 and the smartphone 19. In that case, the e2e transceivers 270a and 270b may reuse the circuitry of RF transceivers 250a and 250b.

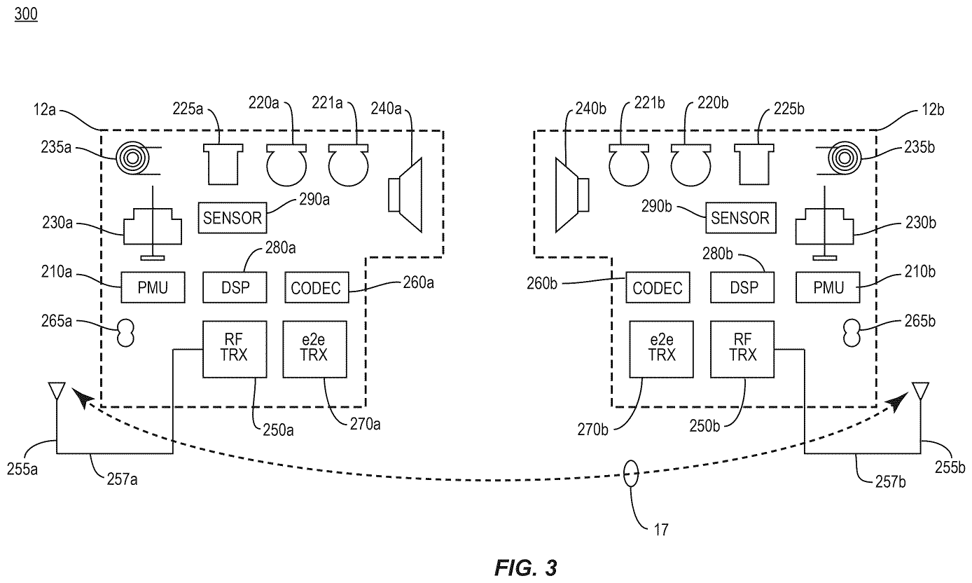

FIG. 3 shows a high-level schematic diagram 300 where link 17 is supported by the transceivers 250a and 250b also being used for communication between the earpieces 12 and the smartphone 19.

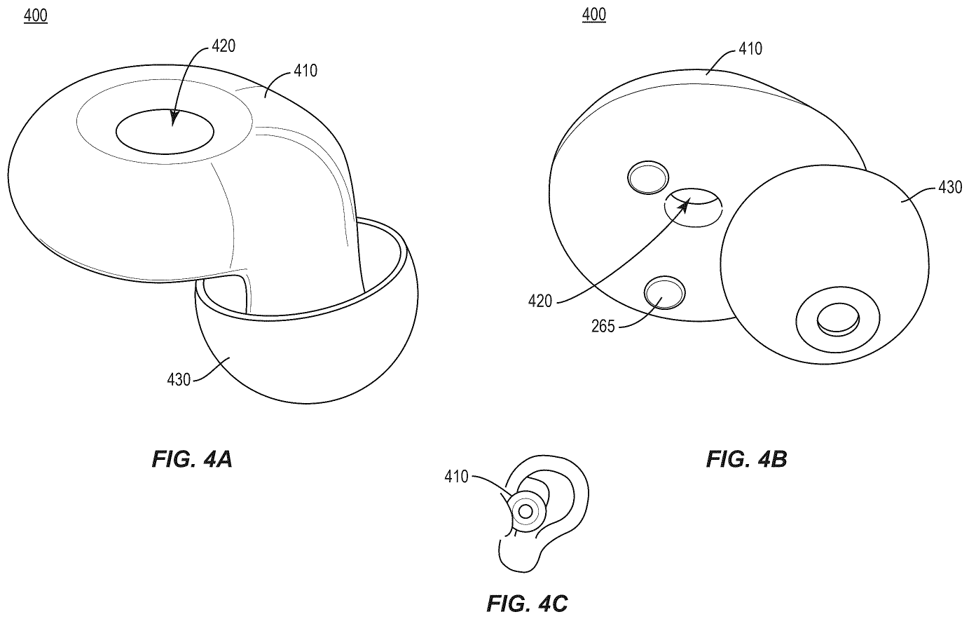

FIGS. 4A and 4B show an exemplary embodiment 400 of the earpiece 12, with several features depicted. FIG. 4C shows the earpiece 12 disposed in a human ear. The earpiece 12 has a donut shaped housing 410 that fits into the human concha, and an ear tip 430 of pliable material, such as silicone or rubber. The ear tip size should block the user's ear canal from environmental sounds. An important characteristic of the donut shape for certain aspects of the invention is the hole 420 in the middle. Charging contacts 265 are present to support (re)charging via a galvanic connection. The shape of the housing 410 itself, and the attachment of the ear tip 430 to this housing 410, achieves a high level of symmetry, which allows the right and left earpieces 12a, 12b to be substantially identical. This also means that the placement of the components in the right and left earpiece 12a, 12b is substantially the same, as are the PCBs on which the electronic components are placed. This not only means ease of use for the user, who does not have to worry about which earpiece 12 to put in his left ear or right ear, but it is also advantageous with respect to manufacturing and economy of scale, since only one type of earpiece 12 must be made.

If needed for functionality, right and left ear wearing can be detected when the user places each earpiece 12 in his ears. For example, using accelerometers, the gravitational force can be measured and will determine in which side of the user's head the earpiece 12 is worn.

Alternatively or additionally, since people are moving forward most of the time, motion sensors can be used to ascertain at which side of the head the earpiece 12 is worn.

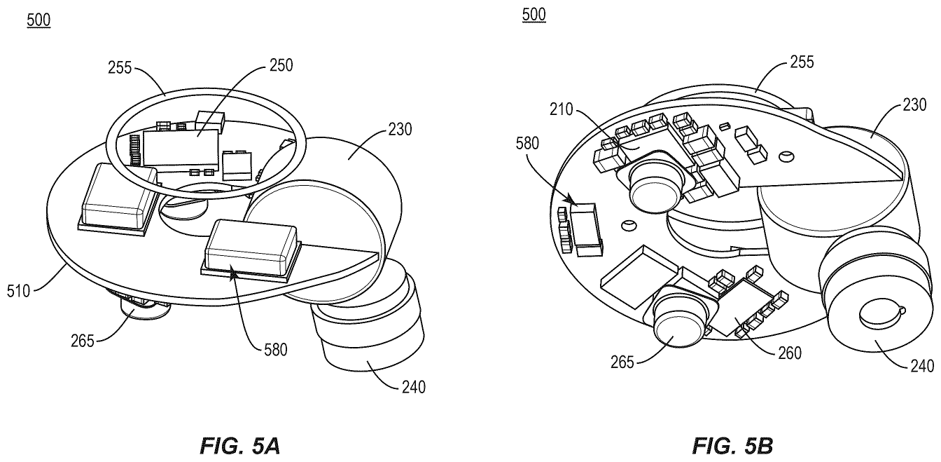

FIGS. 5A and 5B show the internal structures of the earpiece 12 depicted in FIGS. 4A and 4B, respectively. A main PCB 510 includes a base for the electronic components, referred to collectively as 580, and provides electrical connections between these electronic components 580 through a multi-layered PCB. This PCB 510 may be a rigid, flex-rigid, or flex PCB. The PCB 510 is generally washer-or disc-shaped, with a flat circular shape (having a cut-out to accommodate the battery 230) and a central through hole. This shape allows the PCB 510 to be disposed within the donut-shaped housing 410. Antenna 255 is shown as a loop antenna which has sufficient distance above the main PCB 510 with the electronic components so as not to disturb the electromagnetic characteristics of the antenna. Antenna 255 may have a circular geometry which may be centered with the donut hole 420. Antenna 255 is connected to a radio transceiver chip 250 on the main PCB 510. The connection 257 between the antenna 255 and the radio transceiver chip 250 may be galvanic (not shown in FIG. 5) or may use inductive coupling to the main PCB 510. Battery 230 is placed perpendicular to the main PCB 510, such as within a slot formed therein, and is located close to the ear canal of the user where the concha is deepest. Next to the battery 230, at the entrance of the user's ear canal, the loudspeaker 240 is located. The loudspeaker 240 is connected to the codec 265 on the main PCB 510.

The headset device 400 and 500 shown in FIGS. 4A, 4B and FIGS. 5A, 5B includes charging contacts 265 for recharging the battery 230. As explained above, these charging contacts are prone to contamination by dirt and harmful fluids such as salt water. Preferably, a wireless charging method is deployed. Wireless charging may be provided by using a magnetic coupling between a coil in the earpiece 12 and a coil in a charging station. In this way, energy may be transferred from the charging station, which is connected to a mains supply (or has an onboard, large battery), to the battery 230 in the earpiece 12. The magnetic coupling is hampered by metal objects close to the transmit coil (located in the charging station) or the receive coil (located in the earpiece).

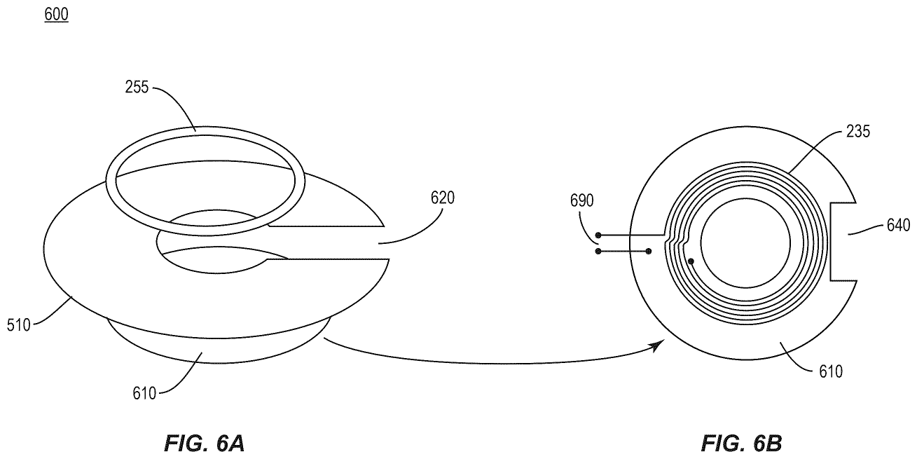

FIG. 6A shows one embodiment 600, in which the receive coil 235 is placed on a second PCB 610 that is located in the bottom of the earpiece 12, i.e., away from the (loop) antenna 255. For completeness, the main PCB 510 is shown with the recess 620 to fit the battery 230. The electronic components 580 are not shown. FIG. 6B shows a top view of the second PCB 610, showing the receive coil 235. Receive coil 235 connects via connector 690 to the PMU 210 located on the main PCB 510. This connection 690 may be accomplished via wires, via a special connector, or via a flex PCB that connects between PCB 510 and PCB 610. Recess 640 in PCB 610 may be needed to fit the battery 230. The receive coil 235 may be realized using multiple copper structures in the multilayered PCB 610. The spiral structures at the different layers may be placed in series and/or in parallel. For efficient energy transfer, the receive coil 235 should have low series resistance and high inductance in order to obtain a high Q (quality) factor.

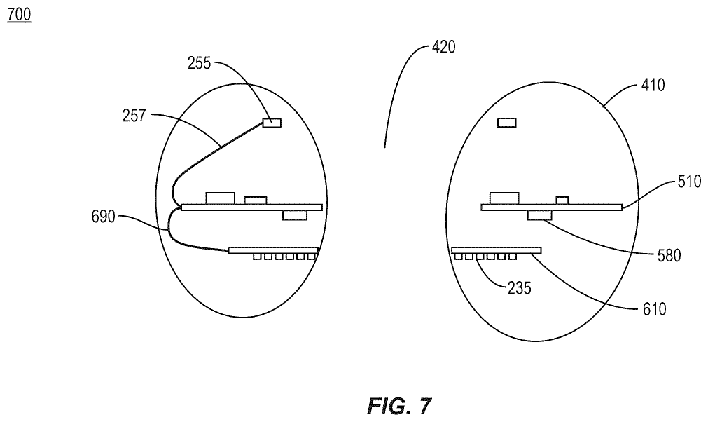

FIG. 7 shows a cross-sectional view of earpiece housing 410 depicting the stacked PCB construction consisting of main PCB 510 containing electronics components 580 and PCB 610 containing receive coil 235. Preferably, the PCB 610 is placed as close to the bottom of the earpiece housing 410 as possible, to provide a large distance between the receive coil 235 and any electronic and metal parts, such as the battery 230 and the loudspeaker 240, that may affect the magnetic field and reduce the efficiency of the energy transfer during wireless charging. Additional ferromagnetic material in the shape of rings (not shown) may be placed between the PCB 610 and PCB 510 acting as a shield in order to increase the magnetic field in receive coil 235.

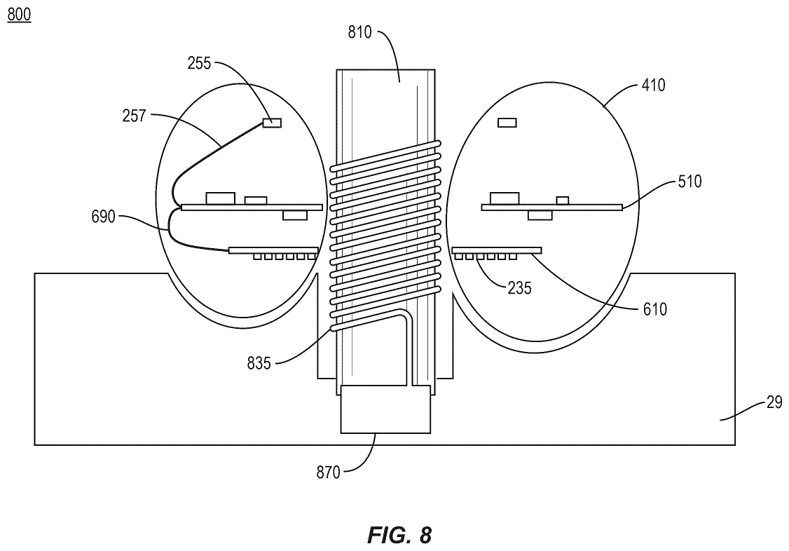

FIG. 8 shows a cross-sectional view of a section of a charging station or cradle 29, where the earpieces 12 may be placed for storage and/or for recharging. In FIG. 8, only a single earpiece 12 is shown. Additional recesses may be present in the cradle housing 29 that match the shape of the earpiece 12. For example, a recess for the ear tip 430 may be present in cradle housing 29 (this recess is not shown in the cross-sectional view of FIG. 8). Permanent magnets may be present to keep the earpiece 12 in place in the cradle 29. A pin 810, which is part of the cradle, fits inside the hole 420 of the donut shaped earpiece housing 410. This pin will also keep the earpiece 12 in place in the cradle 29 which may avoid the need for permanent magnets. In the embodiment 800, preferably this pin 810 is of a ferromagnetic material in order to concentrate the magnetic field and enhance the magnetic coupling between the transmit coil 835 in the cradle 29 and the receive coil 235 in the earpiece 12. Circuitry 870 contains all the electronics for the wireless charging.

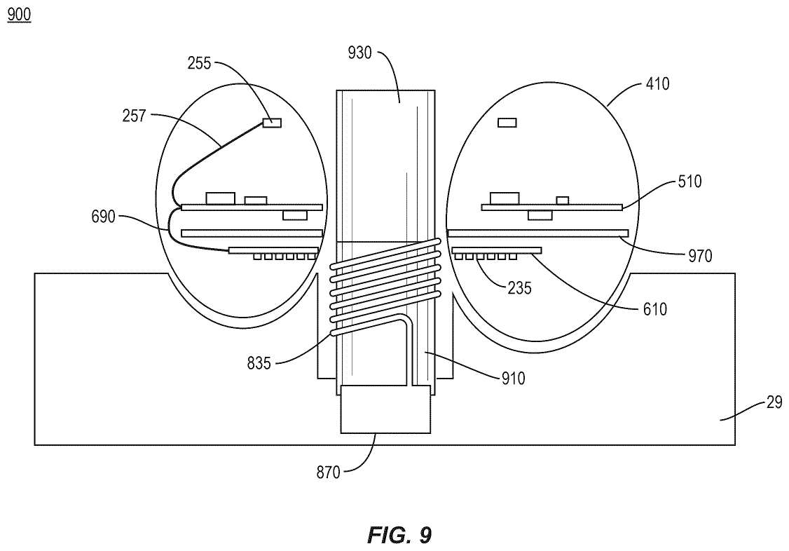

FIG. 9 shows a slightly different embodiment of earpiece 12 and cradle 29. Pin 810 is replaced with a pin having a lower part 910 made of ferromagnetic material and an upper part 930 made of a non-ferromagnetic, non-conductive material, for example plastic. In addition, a shield 970 of ferromagnetic material may be placed between the PCB 610 containing the receive coil 235, and the upper part of the earpiece 12. This shield 970 will also concentrate the magnetic fields, leading them away from metal parts in the earpiece 12. Transmit coil 835 is also placed lower and may only encompass the lower part 910 of the pin.

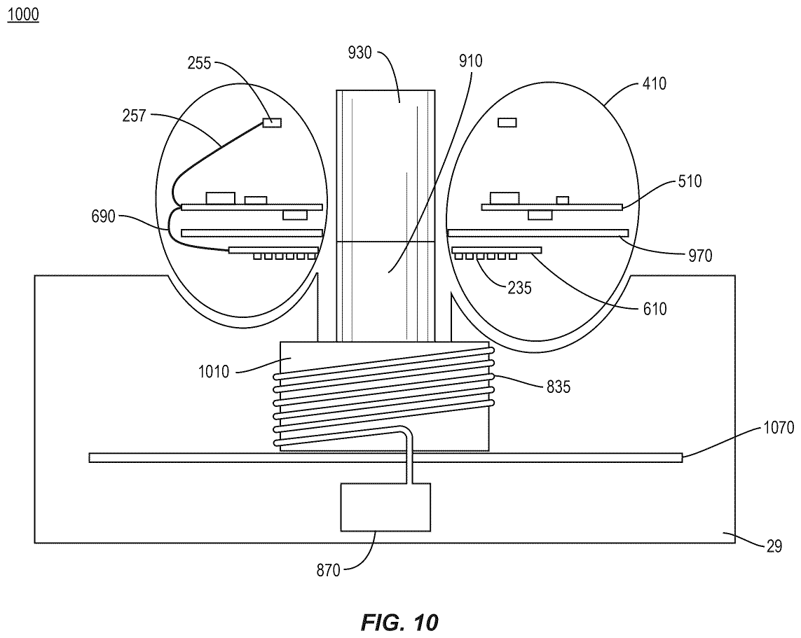

FIG. 10 shows yet another embodiment of earpiece 12 and cradle 29. The diameter of the donut hole 420 may be too small to create a magnetic flux large enough to efficiently charge the earpiece 12. In FIG. 10, the lower part of the pin is separated into a part 910 with a small diameter and a part 1010 with a large diameter; both parts 910 and 1010 are preferably made of a ferromagnetic material.

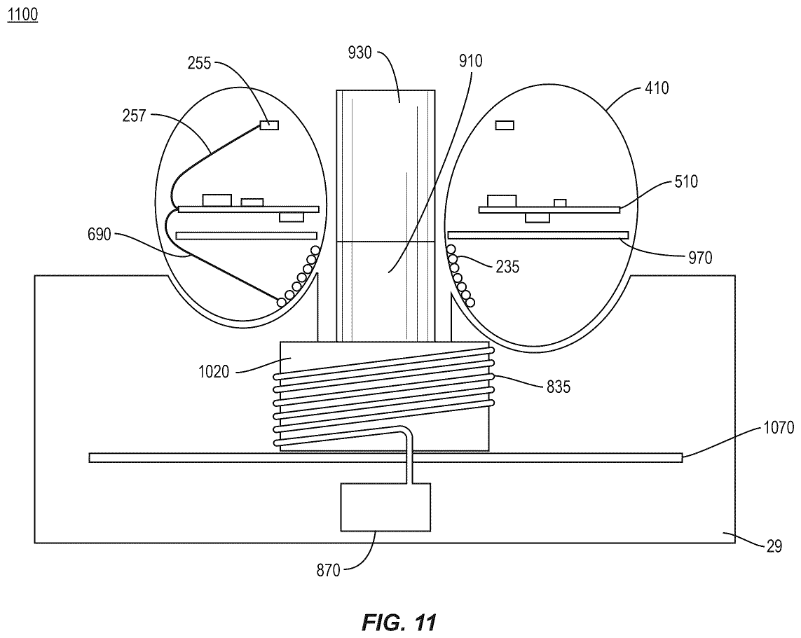

FIG. 11 shows an embodiment in which the windings of receive coil 235 in earpiece 12 are placed against the lower wall of earpiece housing 410, at the bottom of hole 420 for an improved efficiency of the receive coil 235.

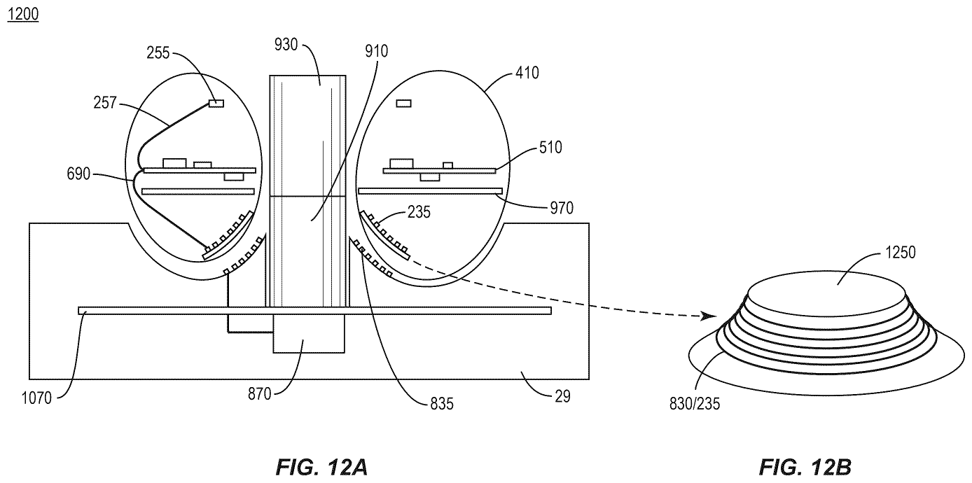

FIG. 12A shows a cross-sectional view where the windings of the receive coil 235 and/or the transmit coil 835 are placed on a prefabricated conical or funnel shaped part 1250, for example of a plastic material. FIG. 12B shows the part 1250 and coil 830/235. The cone 1250, including the receive coil 235, will fit inside the bottom of earpiece housing 410. A similar conical form with transmit coil 835 is disposed inside cradle 29. This conical form fits around pin 910/930.

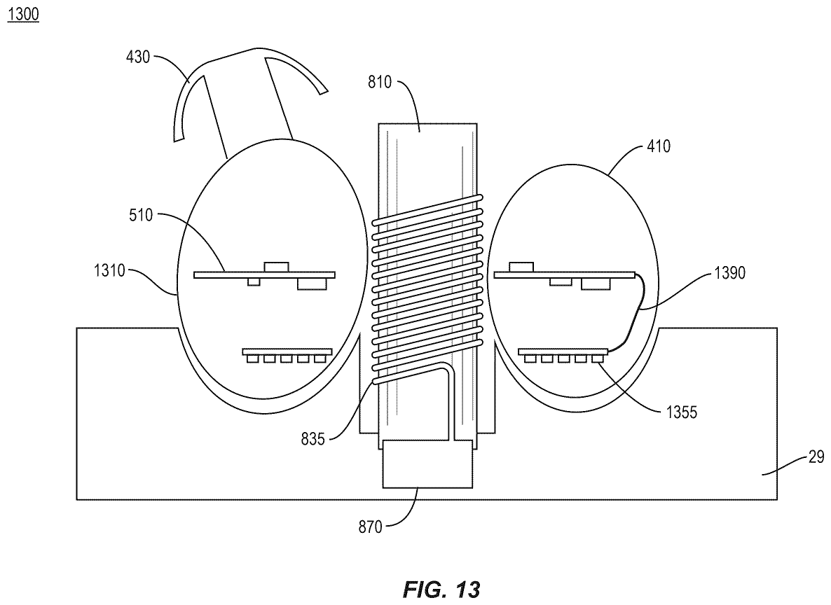

FIG. 13 shows yet another embodiment 1300, in which antenna 255 is reused as receive coil 235 when the earpiece 12 is placed in the cradle. In this case, the earpiece 12 is placed up-side down in the cradle, i.e., with the ear tip 430 facing upwards. In FIG. 13, the configuration of FIG. 8 is reused for the earpiece 12 with a combined antenna/charging coil in wired construction 1355. It will be understood by those of skill in the art that the other charging embodiments shown in FIGS. 9, 10, 11, and 12 can also be modified to fit an earpiece 12 with a combined antenna/charging coil 1355. When the earpiece 12 is located in the cradle 29, the galvanic connector 1390 carries the low-frequency charge currents; when the earpiece 12 is worn in the ear, the galvanic connector 1390 carries the RF signals of the radio signal. To act as a charging coil, the multiple windings in wired construction 1355 should be connected in series; to act as an antenna, the multiple windings in wired construction 1355 should be connected in parallel. Capacitors and/or inductances may be needed to have the windings alter their electrical characteristics at low frequencies (charging) and at high frequencies (antenna). Stray capacitance between the windings may be sufficient and may omit the need for lumped capacitors. Alternatively, electronic switches can be used to connect the windings either in series (charging) or in parallel (antenna), depending on whether the earpiece is located in the charging cradle or not. In a different embodiment, for the antenna functionality only a single winding of wired construction 1355 is used as antenna feed, and EM coupling from this winding to the other windings will cause the entire construction to perform as an antenna.

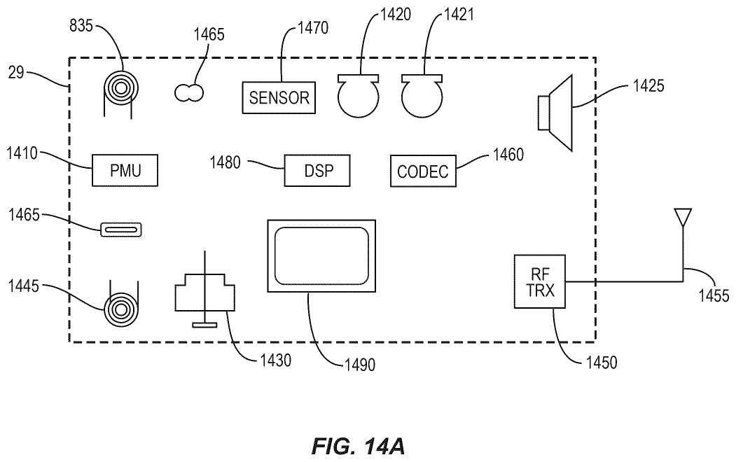

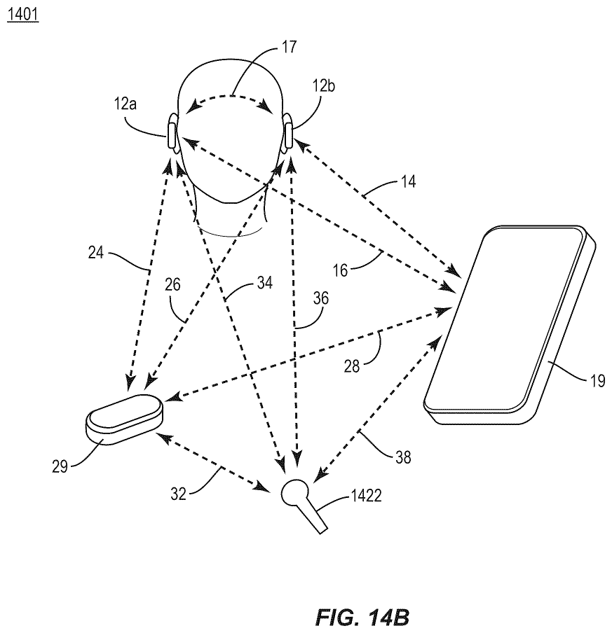

FIG. 14A shows a high-level functional schematic diagram of the electronic components inside cradle 29. In addition to transmit coil 835 for wirelessly charging the earpieces 12, the cradle may have galvanic contacts 1465 to allow wired charging of the earpieces 12. A PMU 1410 is present to supply the transmit coil 835 and/or galvanic contacts 1465, and control the charging process. For example, rechargeable batteries such as lithium batteries are preferably charged by a constant current when the batteries are close to empty, and are preferably charged by a constant voltage when the batteries are close to fully charged. An indication of the status of the battery 230 in the earpieces 12 is given via contacts 1465 when wired charging is applied, or via a radio connection supported by radio transceiver 1450 when wired or wireless charging is applied. Via antenna 1455, the cradle may connect with a radio transceiver in the earpieces 12a/12b, for example radio transceiver 250a and 250b may support links 24 and 26 (FIG. 14B) to the right and left earpieces 12a/12b, respectively. Preferably, the Bluetooth Low Energy (BLE) protocol is used for the wireless charging control function. Alternatively, the wireless charging control may make use of a (bi-directional) link that may reuse the inductive coupling between the transmit coil and the receive coil by modulating the magnetic charge field, for example using the NFMI communication protocol or NFC.

Energy towards the transmit coil 835 or charge current to provide via contacts 1465 may come from the onboard cradle battery 1430 or from a main supply, e.g., via USB connector 1465. Cradle battery 1430 may be a primary battery or may be a rechargeable battery, for example a lithium battery. If rechargeable, battery 1490 may be recharged by mains supply via USB connector or wirelessly via receive coil 1445. In the latter case, the cradle 29 must be placed on a charging mat (not shown). In the charging mat, a transmit coil is integrated that magnetically couples to the receive coil 1445 in the cradle 29 and thus provides energy to the cradle 29 to charge battery 1430.

As shown in FIG. 14B, in addition to controlling the wireless charging, transceiver 1450 may be used for other wireless (control) functionality. The earpieces 12a and/or 12b may communicate other status information to the cradle 29 via links 24 and/or 26. In addition, the cradle 29 may be wirelessly connected to a host device via wireless link 28. Cradle 29 may also contain a microphone 1420 so it may operate as a remote (wireless) microphone. A hearing-impaired user may place the cradle 29 with the microphone 1420 in a strategic position, such as in the middle of a table, in order to pick up the voices from people around him. These voice signals will be sent via the wireless links 24 and/or 26 directly to the loudspeakers 240a and 240b in the right and left earpieces 12a/12b of the headset the hearing impaired person is wearing. One or more microphones 1421 may be added to form an acoustic array that may be used for (adaptive) beam forming. The voice signal picked up by cradle microphones 1420 and/or 1421 may be sent wirelessly via links 24 and/or 26 to the earpieces 12. In the earpieces 12, the voice signals from the cradle may be combined with the voice signals picked by microphones 220 and/or 221 in the right and left earpieces 12a/12b and subsequently be sent via wirelessly links 16 and/or 14 to the phone 19 where they are forwarded to a remote caller. Alternatively, the voice signal picked up by cradle microphones 1420 and/or 1421 may be sent directly to the phone 19 via link 28.

A loudspeaker 1425 may be added to provide speakerphone functionality or to provide wireless speaker functionality for music listening. Wireless link 28 towards the phone 19 may be used to make a telephone connection or to download/stream music from a music service such as SPOTIFY®. Codec 1460 may be added to process the analog and/or digital signals from the microphones 1420/1421 and the analog signals towards the loudspeaker 1425. A DSP 1480 may be added for carrying out advanced audio algorithms such as beam forming, echo cancellation, and noise suppression. A sensor 1470 may be added for example to detect movement or whether the case lid is open or closed. The sensor 1470 may operate together with sensors 290a and 290b in the earpieces 12a/12b to improve the accuracy of the sensing function. The cradle 29 may include an ultraviolet (UV) light source (not shown) that illuminates the ear tip 430 and other parts of the earpieces 12 when the lid is closed. UV light will kill bacteria and may be used to clean the ear tip 430. Cradle 29 may contain a display (touch) screen 1490, for example in the lid of the case. The display may show status information of the earpieces 12a and/or 12b and/or the cradle 29. Furthermore, the touch screen may act as a UI, for example to control audio functionality. Other UI functionality may be added including but not limited to buttons, gesture control, LEDs, etc. Alternatively, the smartphone 19 may be used to control functions in the earpieces 12a and/or 12b, and/or the cradle 29.

USB connector 1465 may be used to connect the cradle via a cable to a 3.5 mm jack, for example in an airplane. The analog audio signals emanating from the 3.5 mm port may be converted by a unit in the cable into digital signals which use the USB protocol. Audio information from the 3.5 mm jack may be forwarded by cradle 29 to earpieces 12 for example to listen to music or audio associated with a movie shown on a screen or display nearby. USB connector 1465 may also be used to connect cradle 29 via a cable to a PC or laptop. The PC or laptop may be used to configure the cradle and/or headset 12 (for example for tuning hearing impaired settings, or assist while testing the leakage in the earpieces 12a and/or 12b). Alternatively, audio information emanating from the PC or laptop may be forwarded by cradle 29 via radio 1450 and antenna 1455 to earpieces 12 for example to listen to music or audio associated with a movie or game shown on the PC or laptop screen. The cradle may be used as hub or base station towards multiple headsets 12. Audio information may be broadcast by radio 1450 to multiple users. The cradle can also act as a hub in a (star) network connecting several headset users to communicate wirelessly among each other. This can, for example, result in an intercom function where users in range of the cradle can communicate with each other. Radio 1450 will relay audio messages between the headset users back and forth.

In some embodiments, cradle 29 may not include a battery 1430. The cradle may then mainly be used for storage purposes and for charging. In this embodiment, for (wirelessly) charging the earbuds, the cradle 29 must be connected to a mains power supply, e.g., wired via a USB cable and connector 1465, or wirelessly via a charging mat. The electronic components shown inside the cradle may be omitted. Alternatively, the electronic components may only operate when the cradle 29 is connected to a mains power supply.

FIG. 14B shows the use scenario depicted in FIG. 1, extended with a wireless microphone 1422. Wireless microphone functionality in the cradle 29 described above can be implemented in an external microphone 1422. This component can be of small size, such as a clip-on device that can be worn by the user on his lapel. The user's voice signals picked up by the wireless microphone 1422 may be sent to phone 19 where they are forwarded to a remote caller. Instead of going directly to the phone 19, the voice signals may be sent wirelessly via links 34 and/or 36 to the earpieces 12a and/or 12b, respectively. Here, the voice signals from the wireless microphone 1422 may be combined with the voice signals picked by microphones 220 and/or 221 in the right and left earpieces and then sent via wireless links 16 and/or 14 to the phone 19, where they are forwarded to a remote caller. Alternatively, the voice signals may be sent to the cradle 29 first, where recording of the voice may take place, and subsequently forwarded to the earpieces 12 or the phone 19. The cradle 29 may have the capability to store and/or (wirelessly) charge the wireless microphone 1422. The microphone 1422 may contain multiple audio pick-up elements to apply beamforming.

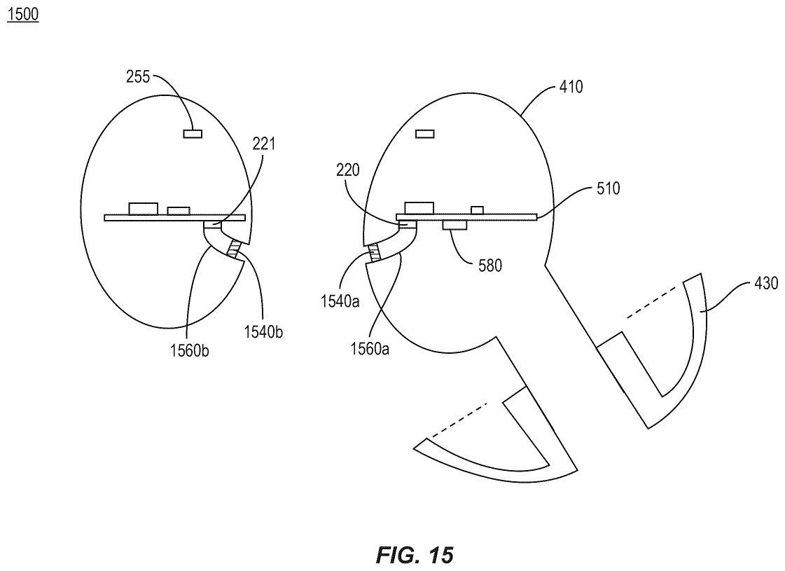

FIG. 15 shows the positions of first and second microphones 220 and 221 inside the earpieces 12 in more detail. A cross-sectional view of one earpiece 12 is presented. First and second acoustic tubes 1560a and 1560b lead to corresponding first and second air entries located in the hole 420 of the donut shaped housing 410. The first and second air entries are facing inside the concha of the user. Dampers 1540a and 1540b may be added into the first and second acoustic tubes 1560a and 1560b, respectively, to attenuate the sound pressure. The dampers 1540a and 1540b may consist of a mesh structure and will keep dirt and moisture away from the microphones 220 and 221, respectively. Both microphone 220 and microphone 221 are placed on the bottom side of PCB 510. Alternatively, microphones 220/221 may be placed up-side-down on the upper side of PCB 510 (not shown) and holes in PCB 510 lead to tubes 1560a/1560b. Depending on the wind conditions (wind direction and wind vortices), the signals of the two microphones 220, 221 are combined (e.g., providing beam-forming) to suppress wind noise as much as possible and favor the voice signal of the user, the voices of other people close by, or the sound of traffic nearby.

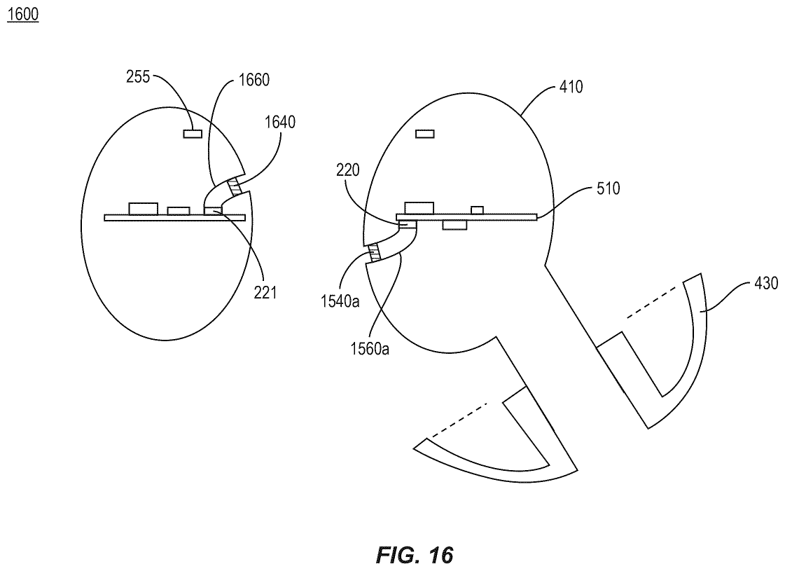

FIG. 16 shows a different the position of the second microphone 221. It is now mounted on top of PCB 510. A third acoustic tube 1660 leads to a third air entry in the hole 420 of the donut shaped housing 410 outward facing, i.e., away from the user's head. Damper 1640 may be added into the third acoustic tube 1660 to attenuate the sound pressure and to keep dirt and moisture away from the second microphone 221. Depending on the wind conditions (wind direction and wind vortices), the signals of the first and second microphones 220, 221 may be combined (e.g., providing beam-forming) to suppress wind noise as much as possible and favor the voice signal of the user, the voices of other people close by, or the sound of traffic nearby. The second microphone 221 may also be used to pick up environmental sounds only. The third air entry could be facing outward and backwards away from the user's mouth (not shown). Additional microphones may be added to form an array for extended beam forming. Also, microphones may be added that pick up the sound in the user's ear canal (not shown), for example for advanced audio processing functions like Active Noise Cancellation and occlusion boost suppression.

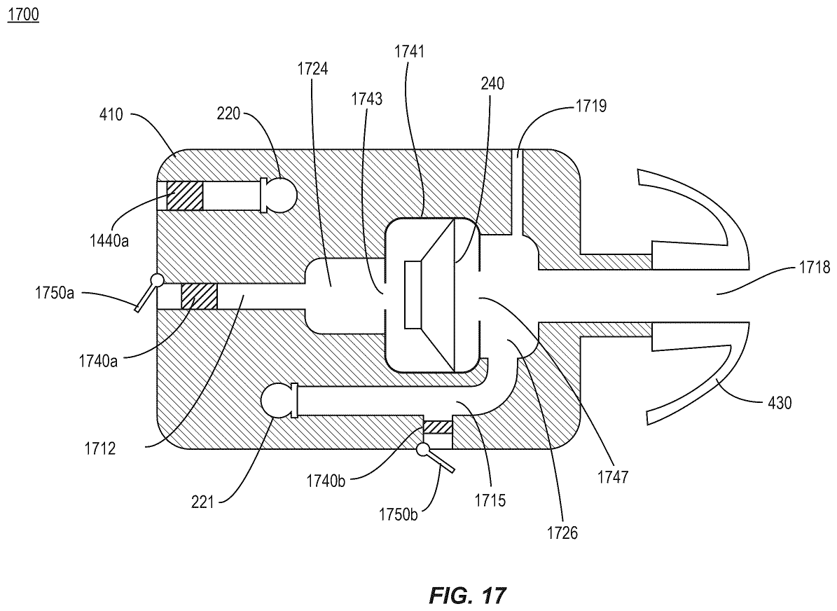

FIG. 17 shows the acoustic system within the earpiece housing. The picture is not to scale and is presented as illustration to explain the various acoustic functions of the system. The inside of the earpiece housing 410 contains several cavities, acoustic tubes, and ducts to guide and manage acoustic waves. A loudspeaker 240 contains a membrane (not shown) and some mechanical driver (not shown) to move the membrane in response to an electrical signal, for example a coil. The loudspeaker may also be constructed with a balanced armature or may use MEMS technology. Speaker 240 is enclosed in a loudspeaker housing 1741 which has entries 1743 and 1747 at the back and the front of the loudspeaker 240, respectively. Sound produced by the vibrations of the membrane is led via entry 1747 to front cavity 1726 and third acoustic tube 1718 to the ear canal of the user. At the back of loudspeaker 240, there is a back cavity 1724 which receives sound waves generated by loudspeaker 240 emanating from back entry 1743. Front cavity 1726 and back cavity 1724 are acoustically separated from each other. A tiny fourth acoustic tube 1719 keeps the ear of the user at an atmospheric pressure level (i.e., prevents a vacuum when the earpiece 12 is pulled out from the user's ear) and provides a proper humidity balance. Fourth acoustic tube 1719 may also include a damper (not shown), for example to provide hearing protection capabilities or to hear the environment at a reduced and safe level even if the earpiece 12 is completely passive, e.g., because the battery 230 is empty.

Connected to the back cavity 1724, a fifth acoustic tube 1712 may lead the sound waves freely to the outside. Damper 1740a may be added to change the air flow and will keep dirt and moisture away from loudspeaker 240. A valve 1750a (e.g., using MEMS technology) may be added which may be opened and closed by an electrical control signal. The earpiece may be placed into a transparent mode, which means that the user may clearly hear all sounds in the environment, possibly at a reduced sound level. Passive transparency may be realized by opening valve 1750a. Sound waves from the environment will enter fifth acoustic tube 1712, cross cavity 1724, and will, via entry 1743, reach the membrane of loudspeaker 240. The membrane will pass along the sound waves which will, via entry 1747, front cavity 1726, and third acoustic tube 1718, reach the eardrum of the user. Passive transparency may also be realized by a sixth acoustic tube 1715 leading directly to the front cavity 1726. Damper 1740b may be added to change the air flow and will keep dirt and moisture away from loudspeaker 240. When valve 1750b is opened, sounds from the environment will then reach the user's eardrum via sixth acoustic tube 1715, front cavity 1726, and tube 1718. When closing valve 1750b (and/or valve 1750a), environmental sounds are blocked from entering the user's ear canal and the user will not hear the environment anymore. In rest position of the valves (e.g., when no electrical signals are provided), their openings should be small enough to pass loud acoustic signals only at reduced levels. This means that when the battery 230 is empty, the user will still be protected against loud noises.

Active transparency may be realized by using microphone 220 and loudspeaker 240. Sounds from the environment are detected by microphone 220, possibly processed in DSP 280 (e.g., amplifying, attenuating, equalizing, compressing) and via codec 260 provided to loudspeaker 240, which will produce the sounds to the user's eardrum. By using active transparency, very loud sounds may effectively be blocked since the dynamic range of the electronic circuitry is limited. Large electrical signals are limited by the transistor output levels. Even loud sounds that occur suddenly, like gunshots, are effectively blocked by the active transparency circuit. Passive and active transparency methods may be combined. For example, fifth and sixth acoustic tubes 1712 and 1715 may be used for passive transparency; depending on their diameters, these tubes may act like low-pass filters suppressing higher frequencies. Additionally, cavities may be added to the tubes that act as acoustic resonators and can be used to flatten (equalize) the acoustic responses. High-frequency signals may be provided by the active transparency circuit which may implement a high-pass transfer response to compensate for the high-frequency loss in the passive transparency (fifth acoustic tube 1712 and/or sixth acoustic tube 1715).

In addition to microphone 220 that picks up signals from the outside, microphone 221 may be added to pick up acoustic signals in the area in front of the loudspeaker 240. The microphone 221 may be placed in the front cavity 1726. Alternatively, as shown, the sixth acoustic tube 1715 may be used to lead the acoustic waves present in the cavity 1726 to the microphone 221. The sound reaching microphone 221 is representative of the sound reaching the eardrum of the user. This microphone 221 may be used for several purposes. Firstly, it may be used for Active Noise Cancellation (ANC). When placed in a negative feedback loop, the system may compare the real audio signal picked up by microphone 221 and the audio signal sent to the loudspeaker 240. The difference may be used as an error signal that can be fed back to the driver of the loudspeaker 240 in an attempt to reduce the error signal as much as possible. The loudspeaker 240 may create anti-sound which cancels any audio present in the area in front of the loudspeaker 240 that is not part of the original audio sent to loudspeaker 240.

Microphone 221 may also be used to do leakage tests of the earpiece 12. When the earpiece 12 does not completely block the user's ear, sound waves from the environment may reach the user's eardrum, possibly leading to hearing damage. Also, leakage results in experiencing the low frequency tones at lower volumes which degrades the listening experience when the user listens to music produced by the loudspeaker 240. To test a tight seal of the earpiece, microphones 220 and 221 may be used. In one test, a loud reference sound is created outside the earpiece and the difference in audio levels of this sound detected in microphone 220 and detected in microphone 221 is a measure of the leakage of the earpiece (valves 1750a and 1750b are closed). The higher the audio level difference measured, the more leakage is present. The reference sound may cover a number of frequencies (frequency sweep) to measure the leakage at different frequencies. Alternatively, while the reference sound is played, valve 1750a and/or valve 1750b may be opened and closed. The difference in audio level measured on microphone 221 is a measure of the leakage. In another leakage test, a reference sound is applied to speaker 240 and the audio level is measured in microphone 221 (valves 1750a and 1750b are closed). The lower the audio level measured (in particular at low frequencies), the more leakage is present. During the leakage test, valve 1750a and/or valve 1750b may be opened and closed to measure the difference and obtain additional information about possible leakage.

In a similar fashion, microphones 220 and/or 221 may be used to determine the amount of sound damping (i.e., protection) the earpieces provide. Comparing the sound levels detected by the external microphone 220 and internal microphone 221 directly yields a measure of sound attenuation by the earpiece. Alternatively, the sound level on internal microphone 221 may be measured with valve 1750b open and valve 1750b closed. The difference in measured sound levels is an indication for the measure of sound attenuation by the earpiece.

The microphone 220 and/or 221 may be used to pick up environmental sound that may be analyzed spectrally to determine the sound levels at different frequencies to which the user is exposed, thus adaptively identifying the audio frequencies and audio levels where damaging sound levels are experienced. From the measured spectrum, filter and/or equalizer settings are then derived and implemented that will suppress signal frequencies where sound levels are high and will let pass signal frequencies where sound levels are low. A combination of passive and active transparency methods can be used that adaptively suppresses as much of the interfering noise as the microphone(s) is experiencing. The methods may be iterative where the settings are adjusted until the in-ear microphone 221 experiences a sound profile not damaging the user's hearing capability.

Microphones 220 and/or 221 may also be used for noise dosimetering. The earpiece may then measure the acoustic noise to which the user is exposed, integrated over a period of time. Microphone 220 may monitor the dose outside the user, whereas microphone 221 may monitor the dose as experienced by the user's eardrum. To save power, duty-cycling may be applied, for example the audio level on the microphone(s) is determined for a period of one second every 30 seconds. Special attention may be paid to time instances where audio levels are high.

Microphone 221 may also be used to compensate for the occlusion effect. Occlusion occurs when the user's ear canal is blocked. This blocking results in a perceived boost of lower frequencies. As a result, the user experiences his own voice as sounding distorted, is more aware of body sounds (jaw movements when chewing, eating, yawning), and experiences motion sounds like bounces when walking and jumping. The boost in the lower frequencies may be reduced by the loudspeaker 240, creating anti-sound in a similar way as for ANC.

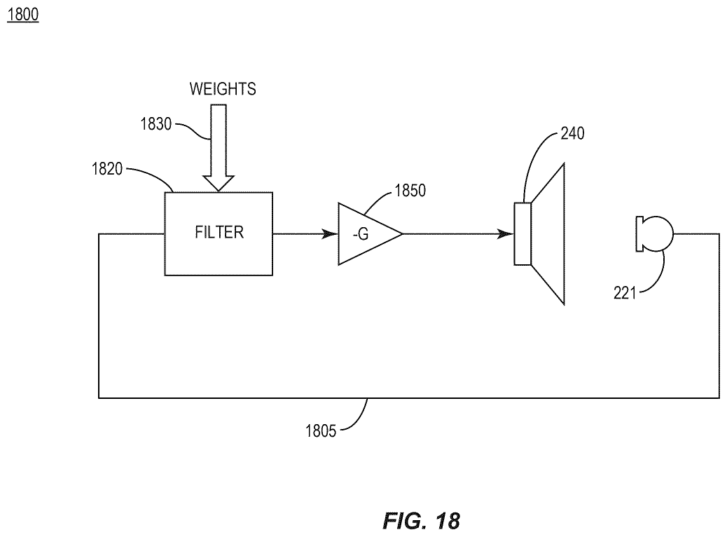

FIG. 18 shows a circuit to realize the cancellation of lower frequencies. Acoustic signals in the ear canal are detected by in-ear MIC 221. Via feedback path 1805, the MIC signal is fed back to a digital filter 1820. If an analog MIC is used, an A-to-D conversion (not shown) is needed in the feedback path 1805. The filter 1820 shapes the signal such that only low frequencies are suppressed, and the loop does not become instable, which might cause oscillations. Filter 1820 may for example be a Finite Impulse Response (FIR) filter or an Infinite Impulse Response (IIR) filter. Inverter 1850 with gain-G creates the anti-sound which is fed to the loudspeaker 240. The inversion and gain may also be incorporated in the weights 1830 of filter 1820. The weights 1830 of the filter 1820 may be modified adaptively. For example, when the earpiece detects that there is no loud environmental noise, it may open valve 1750b (and/or valve 1750a) to provide passive transparency and/or provide an opening to the outside, lifting the blockage that led to the occlusion effect. Using machine learning algorithms in DSP 280, the system may learn how the user's voice is perceived when there is no occlusion (valve 1750b and/or valve 1750a is opened) by analyzing the audio measured in microphone 221 when the user is talking. The fact that the user is talking may, for example, be detected by the vibration sensor 225. When valve 1750b and valve 1750a are closed and occlusion occurs, the machine learning algorithm may predict the proper filter weights 1830 such that the user's voice signals measured by microphone 221 are experienced as if no occlusion were present.

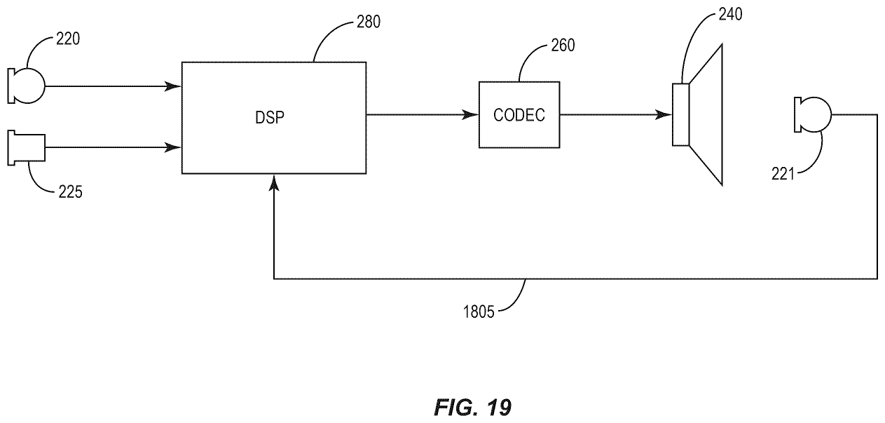

FIG. 19 shows a schematic of the electronic circuitry with components that control the acoustic system. Audio algorithms are preferably running in a low-power DSP 280. Environmental acoustic signals are picked up by microphone 220. Acoustic signals as experienced by the user's eardrum are picked up by microphone 221. Vibration sensor 225 may pick up body sounds like the user's voice. Loudspeaker 240 may produce anti-sound to cancel or reduce sound that should not reach the eardrum. Loudspeaker 240 and microphone 221 may also be used for deploying leakage tests. DSP 280 may include hearing aid functionality. In the active transparency mode where the signals picked up by microphone 220 are fed to loudspeaker 240, compression and amplification may take place at different frequencies, thus compensating for hearing loss of the user for example at specific frequencies. Codec 260 includes D-to-A conversion to drive speaker 240 with an analog signal. DSP 280 and/or codec 260 may also include audio filters to customize the hearing experience according to a preferred acoustic response.

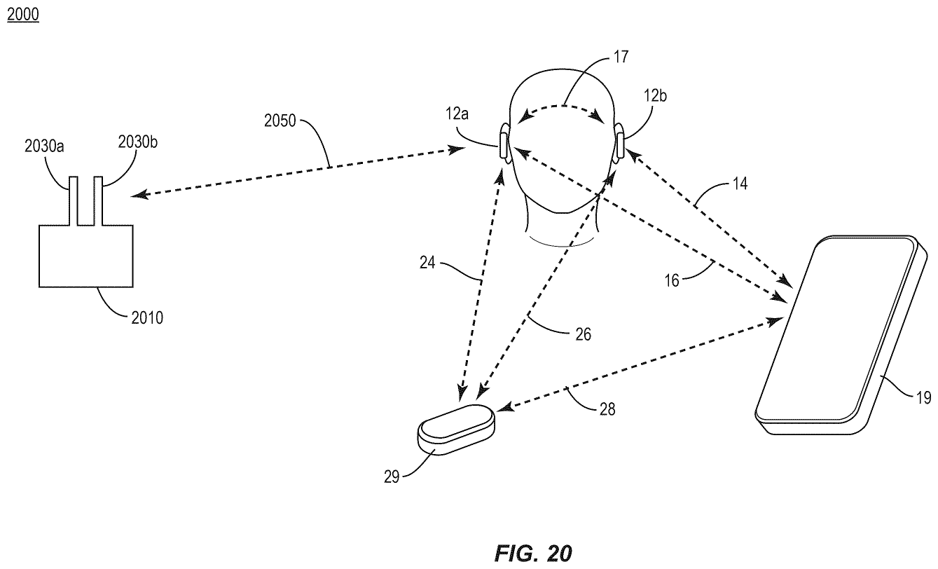

FIG. 20 shows that a headset 12 used, e.g., by factory workers, may also be connected to a central hotspot 2010. While listening to their favorite music stored on their phone via wireless connections 14, 16, the music may be interrupted by messages carried over wireless link 2050 and transmitted by the central hotspot 2010. These messages may include working instructions. The user may respond over wireless link 2050 for example to consult with his foreman or manager. Hotspot 2010 may have antennas 2030a and 2030b to efficiently transmit and receive radio signals. These signals may be based on Bluetooth Low Energy, possibly using the Auracast broadcasting mode. Via link 2050, the user of headset 12 may also be able to communicate wirelessly to his colleagues that may also be connected to hotspot 2010 (or to the infrastructure of which hotspot 2010 is a part).

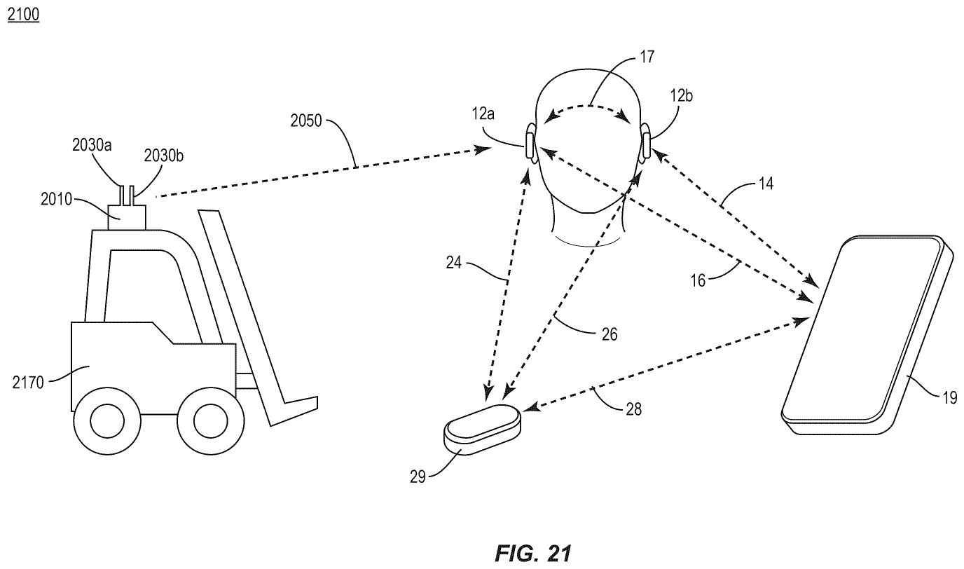

FIG. 21 addresses a scenario 2100 in which factory workers working in environments with loud noises wearing the hearing protection earpieces 12 may not hear warning signals, like honking sounds from moving vehicles on the factory floor, for example forklift trucks, but the factory worker wearing earpieces 12 is warned of nearby vehicles. A wireless transmitter 2110 is mounted on forklift truck 2170. Via a broadcast link 2050, workers nearby are made aware of the presence of forklift truck 2170, for example by an audio signal in earpieces 12. The warning signal over link 2050 may only be conveyed to the worker if the distance between forklift truck 2170 and the worker is below a certain threshold. The distance may be determined using a wireless ranging method, for example based on signal strength level, and/or may be based on the Ranging Service and High Accuracy Distance Measurement specified in the Bluetooth standard. Alternatively, a distance measurement method based on Ultra Wideband (UWB) may be used. In the latter case, UWB transceivers would be required in both the forklift truck 2170 and the earpieces 12. Other distance measurement techniques based on reflection, for example based on radar technology or vision systems (cameras) may be used, which may be implemented in hotspot 2110 or forklift truck only. Angle measurements (like Angle-of-Arrival AoA, or Angle-of-Departure AoD as defined in the Bluetooth specification) may be used instead of or in addition to distance measurements. If the angle is (quickly) changing over time, this means that the vehicle is not moving towards (or from) the headset user, thus reducing the probability of a collision.

The combination of wireless messaging and distance measurements may also be used in different ways. If the measurement method is also implemented in the scenario of FIG. 20, the user may only receive messages when sufficiently close to hotspot 2010. For example, wireless transmitter 2010 may be mounted on a machine or tool with a particular sound image or sound signature. This signature may be broadcasted by transmitter 2010 over link 2050 to wireless headset 12. Wireless headset 12 may now adapt its audio settings to suppress as much of the damaging sound as possible, while allowing other sounds to reach the eardrum. For example, when the machine is an angle grinder with a high pitch, the earpieces 12 may tune their audio settings to suppress high frequencies while allowing low frequencies to enter the eardrum. The user may be able to continue talking and listening to nearby persons. Furthermore, the earpiece may (partly) open valves 1750 to allow passive transparency for low frequencies, and in addition reduce occlusion effects. For machines that produce a low frequency buzzing sound, active transparency may be used so that earpieces 12 only let pass high frequency sound, thus preventing the low-frequency buzz to reach the eardrum. Using the radio transmitters and the distance measurement on the machine, tools, and equipment, users are assured of the highest protection level combined with the highest comfort level regarding transparency.

Instead of using radio transmitters on the tool or machine, the tool or machine may carry an optical code, such as a Quick Response (QR) code, on its surface. By scanning the QR code by a smartphone 19, the sound signature of the tool may be directly obtained. Alternatively, the QR code may encode a Uniform Resource Locator (URL) containing the sound signature. From this sound signature, the optimal audio settings for suppressing the tool's damaging sounds are derived. Alternatively, the optimal audio settings for suppressing the tool's damaging sounds may be directly indicated in the QR code. These settings may subsequently be forwarded to the headset 12 via links 14 and 16, and will implement the proper filter response of the acoustic system in earpieces 12. A combination of passive and active transparency methods can be used.

The personalization of sound experience in earpieces 12 may also be done by the user interactively via an App on the smartphone 19. The App may provide pre-defined sound profiles that for example only suppress high frequencies or only suppress low frequencies. The user may find the optimal cutoff frequency (e.g., the frequency where the sound power has been reduced by 3 dB) using a sliding bar on the touch screen of his smartphone. However, via the App, the user may also be able to adjust the sound level interactively and live on location. By a graphical interface on the smartphone, the user may choose a filter transfer (equalization) function that suppresses most of the damaging environmental noise while letting pass other sounds. For example, when the user hears a strong, high-pitched noise at 6 kHz, he may choose a filter setting having a notch at 6 kHz. He may fine tune this setting via the App while listening and find an optimal setting that combines suppression of the annoying and damaging noise while keeping a high level of comfort. The user may also fine tune the setting to compensate for hearing loss, or to configure his personal audio profile, customized to his personal preferences. The setting may make use of the active and/or passive transparency mechanisms described before to achieve the desired audio experience. Settings may also be changed by using the UI functionality on the earpieces 12. For example, a tap on the an earpiece 12a and/or 12b may switch between a transparent and non-transparent mode. The tap function can also be combined with pre-defined or user-defined audio settings. For example, the user may have his personal “car settings” which he has tuned once while sitting in the car, removing most of the car's annoying noise. The car setting may be stored for future use. Every time when entering the car, the user may tap to the desired car settings. If a list of profiles exists, the user can scroll through the list by tapping repeatedly, where after each tap, an acoustic prompt is played to the user indicating which profile has been selected. Alternatively, a broadcast system as shown in FIG. 20 may be used, where transmitter 2010 is mounted in the car. The car settings are conveyed automatically by transmitter 2010 to the user headset 12 when the user enters the car (e.g., as detected by the distance measurement system).

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features and advantages of the enclosed aspects will be apparent from the description. The terms “first,” “second,” and the like are terms of reference, used to distinguish between similar features, components, functions, devices, etc. These terms do not imply any temporal order or hierarchy of importance, priority, or the like. Furthermore, the use of such a reference term to uniquely identify one feature, component, function, device, etc. does not imply the presence of any other feature, component, function, device, etc. For example, a device including a “third” feature does not necessarily include first and/or second such features the included feature is merely the third such feature described in the present disclosure. As used herein, the term “configured to” means set up, organized, adapted, or arranged to operate in a particular way; the term is synonymous with “designed to,” or with respect to processing circuitry, “programmed to.”

As used herein, the term “donut” or “donut shaped” or the like refers to a generally torus-like, or toroidal, shape. A toroid is a three-dimensional surface generated by a closed plane curve (such as a circle) rotated about a line that lies in the same plane as the curve but does not intersect it. A salient feature of a donut or toroidal shape is that it has a central hole.

The headset and its constituent earpieces are collectively referred to herein by the reference numeral 12. When discussing one or the other individual earpiece, they may be designated as 12a for the right earpiece and 12b for the left earpiece, where “right” and “left” are from the perspective of the user, as depicted in FIGS. 1, 14B, 20, and 21. Where the two earpieces are referenced collectively but distinction between right and left is not critical, they may be refenced as either 12a/12b or simply 12.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended embodiments are intended to be embraced therein.

What is claimed is:

1. A wearable, true wireless earpiece, comprising:
a donut shaped housing having a through hole in the center, shaped and configured to be placed in a concha of a user's ear;
an ear tip shaped and configured to be placed in a canal of the user's ear, and to substantially block ambient sound from the user's ear, the ear tip having a central bore comprising a main acoustic tube configured to carry sound to the user's ear;
a main washer-shaped Printed Circuit Board (PCB) having a central through hole, disposed in the housing and providing physical support and electrical connectivity to electronic circuits disposed thereon and configured to perform communication and audio processing functions; and
a circular Radio Frequency (RF) antenna disposed within the housing, and spaced away from the main PCB.

2. The earpiece of claim 1 wherein the main PCB includes a recess formed therein at a first radial position, and further comprising a battery disposed within the recess, generally perpendicular to the main PCB.

3. The earpiece of claim 2 further comprising a second washer-shaped PCB, spaced apart from the main PCB on an opposite side from the RF antenna, the second PCB comprising electrical traces forming a power receiving coil.

4. The earpiece of claim 3 wherein the second PCB includes a recess formed at least partially therein at the first radial position and configured to receive the battery.

5. The earpiece of claim 1 wherein the RF antenna comprises electrical traces on a third washer-shaped PCB spaced away from the main PCB, and wherein the electrical traces on the third PCB additionally function as a power receiving coil.

6. The earpiece of claim 5 further comprising circuitry on the third PCB configured to configure the electrical traces in series to function as the power receiving coil and to configure the electrical traces in parallel to function as the RF antenna.

7. The earpiece of claim 1 further comprising a first microphone disposed on the main PCB, the first microphone in audio reception relationship with the ambient environment via a first acoustic tube extending between the first microphone and a first air entry located in the through hole of the donut shaped housing.

8. The earpiece of claim 7 further comprising a damper interposed in the first acoustic tube and configured to attenuate sound pressure and protect the first microphone from dirt and moisture from the ambient environment.

9. The earpiece of claim 7 further comprising a second microphone disposed on the main PCB, the second microphone in audio reception relationship with the ambient environment via a second acoustic tube extending between the second microphone and a second air entry located in the through hole of the donut shaped housing, generally opposite the first air entry.

10. The earpiece of claim 7 further comprising a second microphone disposed on the opposite side of the main PCB from the first microphone, the second microphone in audio reception relationship with the ambient environment via a second acoustic tube extending between the second microphone and a second air entry located in the through hole of the donut shaped housing, generally opposite the first air entry and directed in a direction different that the first air entry.

11. The earpiece of claim 7 further comprising a loudspeaker assembly comprising:
a loudspeaker comprising a membrane and a mechanical driver configured to move the membrane in response to an electrical signal; and
a loudspeaker housing generally enclosing the loudspeaker, the loudspeaker housing including front and back acoustic entries.

12. The earpiece of claim 11 wherein the loudspeaker is acoustically connected to a user's ear via a front acoustic path comprising:
a front cavity acoustically connected to the front entry of the loudspeaker housing; and
a third acoustic tube connected between the front cavity and an open end of the ear tip.

13. The earpiece of claim 12 wherein the earpiece implements active transparency, wherein the earpiece amplifies sounds in the ambient environment and directs them to the user's ear, by detecting sounds in the first microphone, rendering the sounds by the loudspeaker, and propagating the sounds to the user's ear via the front acoustic path.

14. The earpiece of claim 12 wherein the front acoustic path further comprises a fourth acoustic tube connected between the front cavity and the ambient environment via an air entry in the donut shaped housing, wherein the fourth acoustic tube is configured to maintain atmospheric pressure and humidity at the user's ear.

15. The earpiece of claim 12 wherein the front acoustic path further comprises a sixth acoustic tube connected between the front cavity and the ambient environment via an air entry in the donut shaped housing.

16. The earpiece of claim 15 wherein the sixth acoustic tube is acoustically connected to a second microphone disposed on the main PCB, which thereby receives sounds generated by the loudspeaker and coupled to the front chamber, which are representative of sounds reaching the user's ear via the front acoustic path.

17. The earpiece of claim 16 wherein the earpiece performs Active Noice Cancellation (ANC) in a negative feedback loop, wherein an audio signal received by the second microphone and audio signals sent to the loudspeaker are compared to generate an error signal that is fed back to a driver of the loudspeaker so as to reduce the error signal, thus creating anti-sound that cancels audio present in the front cavity that is not part of an original audio signal sent to the loudspeaker.

18. The earpiece of claim 16 wherein the earpiece performs a leakage test wherein a reference sound generated outside the earpiece, and signals generated by both the first microphone coupled to the ambient environment, and the second microphone coupled to the front chamber, and compared to ascertain a level of leakage.

19. The earpiece of claim 16 wherein the earpiece performs a sound damping test by comparing signals generated by both the first microphone coupled to the ambient environment, and the second microphone coupled to the front chamber.

20. The earpiece of claim 15 wherein the air entry connecting the sixth acoustic tube to the ambient environment includes a valve configured to selectively occlude the air entry or to partially or fully open the air entry to the ambient environment.

21. The earpiece of claim 20 wherein the earpiece implements passive transparency, whereby the user may hear sounds in the ambient environment, by opening the valve of the air entry connecting the sixth acoustic tube to the ambient environment, thus creating an acoustic path from through the front acoustic path to the user's ear.

22. The earpiece of claim 9 wherein the loudspeaker is acoustically connected to a rear acoustic path comprising:
a rear cavity acoustically connected to the rear entry of the loudspeaker housing; and
a fifth acoustic tube connected between the rear cavity and the ambient environment via an air entry in the donut shaped housing.

23. The earpiece of claim 22 wherein the air entry connecting the fifth acoustic tube to the ambient environment includes a valve configured to selectively occlude the air entry or to partially or fully open the air entry to the ambient environment.

24. The earpiece of claim 23 wherein the earpiece implements passive transparency, whereby the user may hear sounds in the ambient environment, by opening the valve of the air entry connecting the fifth acoustic tube to the ambient environment, thus creating an acoustic path from through the rear acoustic path, the loudspeaker, and a front acoustic path acoustically connected between the front entry of the loudspeaker housing and the user's ear.

25. A cradle configured to store and wirelessly recharge batteries in first and second earpieces of a true wireless headset, the cradle comprising a housing and including, for each earpiece:
a recess conforming to the donut shaped housing the earpiece and configured to hold the earpiece;
a generally vertical pin sized centrally located in the recesses and configured to protrude through the through hole in the center of the earpiece;
an energy transmitting coil configured to create a magnetic field coupling the energy transmitting coil to the energy receiving coil and to wireless transfer energy to the earpiece; and
circuitry configured to control the energy transmitting coil.

26. The cradle of claim 25, further comprising permanent magnets configured to securely hold each earpiece in its respective recess.

27. The cradle of claim 25, wherein each pin in the cradle is at least partially formed of a ferromagnetic material and the energy transmitting coil is wound around at least a part of the pin, wherein the pin and energy transmitting coil are configured to concentrate the magnetic field and enhance the magnetic coupling between the energy transmitting coil and the energy receiving coil.

28. The cradle of claim 27, wherein each pin in the cradle comprises a ferromagnetic material in lower portion, and a dielectric material in an upper portion, and wherein the energy transmitting coil is wound around only the ferromagnetic portion of the pin.

29. The cradle of claim 28, wherein the lower portion of each pin comprises an upper pin portion having a first diameter and a lower pin portion having a second diameter larger than the first diameter, wherein:
the upper pin portion protrudes at least partially through the through hole in the donut shaped housing of an earpiece;
the lower pin portion is disposed withing the housing of the cradle, and
the energy transmitting coil is wound around the lower pin portion.

30. A true wireless headset system, comprising:
first and second earpieces, each earpiece comprising:
a donut shaped housing having a through hole in the center, shaped and configured to be placed in a concha of a user's ear;
an ear tip shaped and configured to be placed in a canal of the user's ear, and to substantially block ambient sound from the user's ear, the ear tip having a central bore comprising a main acoustic tube configured to carry sound to the user's ear;
a main washer-shaped Printed Circuit Board (PCB) having a central through hole, disposed in the housing and providing physical support and electrical connectivity to electronic circuits disposed thereon and configured to perform communication and audio processing functions;
a circular Radio Frequency (RF) antenna disposed within the housing, and spaced away from the main PCB; and
a power circuit comprising a rechargeable battery, an energy receiving coil, and electronic configured to recharge the battery using power received by the energy receiving coil; and
a cradle configured to store and wirelessly recharge batteries in the first and second earpieces, the cradle comprising a housing and including, for each earpiece:
a recess conforming to the donut shaped housing of the earpiece and configured to hold the earpiece;
a generally vertical pin sized centrally located in the recesses and configured to protrude through the through hole in the center of the earpiece;
an energy transmitting coil configured to create a magnetic field coupling the energy transmitting coil to the energy receiving coil and to wireless transfer energy to the earpiece; and
circuitry configured to control the energy transmitting coil.
